(19) United States
(12) Patent Application Publication
(10) Pub. No.: US 2023/0211997 A1
(43) Pub. Date: Jul. 6, 2023

(54) METHOD FOR CAPTURING, ANALYZING, AND DISPENSING BEVERAGE ORDERS

(71) Applicant: Starbucks Corporation, Seattle, WA (US)

(72) Inventors: Paul Alexander Bruffett, Seattle, WA (US); Tyson Mark Colby, Seattle, WA (US)

(21) Appl. No.: 17/646,637

(22) Filed: Dec. 30, 2021

(51) Int. Cl. B67D 1/08; G05B 15/02; B67D 1/00

(52) U.S. Cl. CPC B67D 1/0888; G05B 15/02; B67D 1/0015

(57) ABSTRACT

The disclosure generally relates to a system for managing and dynamically generating beverage recipes. The system can obtain an ingredient modifier and can generate a beverage recipe based on the ingredient modifier and a recipe generation policy. The system can cause an automated dispensing system to automatedly dispense a group of ingredients in accordance with the beverage recipe.

### FIELD

The present disclosure generally relates to maintaining a collection of beverage recipes, dynamically generating new recipes based on customer orders, or controlling an automated beverage dispensing platform to automatedly dispense a customized beverage in accordance with a recipe.

### BACKGROUND

Beverages at a coffee store are often associated with standard recipes, and customers can request modifications to a standard recipe, such as to add or remove a particular flavoring. Conventionally, in response to receiving a beverage order, a barista recollects the recipe from memory and creates the beverage by manually pumping ingredients from their respective containers.

### BRIEF DESCRIPTION OF THE DRAWINGS

FIG. 1 illustrates an embodiment of a beverage management and dispensing environment.

FIG. 2 illustrate an example automated dispensing system.

FIG. 3 is a data flow diagram illustrating an embodiment of a data flow and communications between a variety of the components of the beverage management and dispensing environment to dynamically generate a recipe for a beverage in accordance with a recipe generation policy.

FIG. 4 is a flow diagram illustrative of an embodiment of a routine implemented by the recipe manager to dynamically generate a recipe for a beverage in accordance with a recipe generation policy.

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

### DETAILED DESCRIPTION

Beverages at a coffee store are often associated with standard (or default) recipes. In general, each standard recipe is a predetermined recipe with specific ingredients and ingredient proportions, designed to yield a particular taste or calorie count, follow a particular dietary restriction, or the like. Conventionally, in response to receiving a beverage order, a barista recollects the recipe from memory and creates the beverage by manually pumping ingredients from their respective containers. However, in many cases, despite following the same recipe instructions, manually creating beverages often results in inconsistent beverage compositions, at least because a ‘pump’ of an ingredient is not a precise volumetric.

Furthermore, customers often request modifications to the standard recipe. For example, a customer may want half the sugar and twice the amount of vanilla flavor, as compared to the standard recipe for a particular beverage. Conventional pump systems allow for a reduction in a discrete number of manual pumps, but do not allow for a fraction of a pump of an ingredient (for example, syrup, sauce, or flavor) to be pumped. This is inherently problematic to the customer experience, as customers want more customization with precise control. Additionally, ingredient modifications often complicate beverage orders and further exacerbate the inconsistencies between beverages of the same recipe. For example, a customer ordering the same beverage on multiple occasions may ultimately receive beverages with noticeably different beverage compositions, which can negatively affect the customer's experience. Furthermore, because modifications unavoidably modify ingredient proportions, ingredient modifications can undesirably detract from the original intent and/or flavor profile of the beverage.

To address these or other concerns, disclosed herein is a system for maintaining a recipe catalog and controlling a dispensing system to automatedly dispense ingredients in accordance with a recipe. By maintaining the recipe catalog locally and/or on a remote system accessible to a fleet of dispensing systems via a network, the system can advantageously improve beverage uniformity amongst the dispensing systems. Furthermore, by automating the dispensing of ingredients, the system advantageously improves beverage quality and consistency.

Further disclosed is a system for dynamically generating beverage recipes in accordance with a recipe generation policy. The recipe generation policy can indicate how to adjust a recipe to compensate for ingredient modifications. Consider a scenario in which a customer requests an additional shot of espresso for her beverage. In such a scenario, simply adding the additional shot of espresso to the standard recipe, without modifying the other ingredients of the recipe, may result in a beverage with a slightly more bitter taste, as compared to the standard recipe. In such a scenario, the recipe generation policy may indicate a specific set of rules for compensating for the increased bitterness introduced by the additional espresso shot. For example, the recipe generation policy may indicate to compensate for the espresso shot by adding chocolate sauce (for example, proportional to the volume of added espresso) to counteract the bitterness of the espresso and removing steamed milked (for example, proportional to the volume of added espresso and chocolate sauce) to compensate for the increased fluid volume. By dynamically generating beverage recipes based on ingredient modifications, the system can advantageously preserve certain flavor profiles or qualities of a beverage, notwithstanding the ingredient modifications.

In light of the description herein, it will be understood that the embodiments disclosed herein substantially improve beverage quality and consistency across a fleet of dispensing systems by automating the derivation of ingredients for any of thousands or millions of possible ingredient modifications/combinations. Specifically, the embodiments disclosed herein enable a system to receive orders, derive recipes (including, for example, ingredients, precise volumes of ingredients, and sequence instructions), and facilitate precise, automated dispensing of a beverage in accordance with a derived recipe. The ability to derive recipes (for example, in real time or near real time) and facilitate automated dispensing of a beverage improves beverage quality and consistency by precisely dispensing the beverage ingredients in accordance with a derived recipe; reduces beverage-creation time, as less time is spent by baristas measuring and/or manually pumping ingredients; and reduces complexity, memorization effort, and training burden, by reducing required recipe memorizations and mentally-performed recipe modifications. Furthermore, the automated dispensing system advantageously includes fewer plastic containers or pump assemblies, which advantageously reduces waste in the form of smaller packaging for ingredients, and reduces cleaning time for pumps and assemblies. Furthermore, by automating dispensing and improving precision, the system can improve the ability to determine and track detailed actuals for ingredient consumption, which advantageously reduces manual inventory counting and estimation, thereby improving accuracy in tracking inventory and planning for inventory restocking.

### Environment Overview

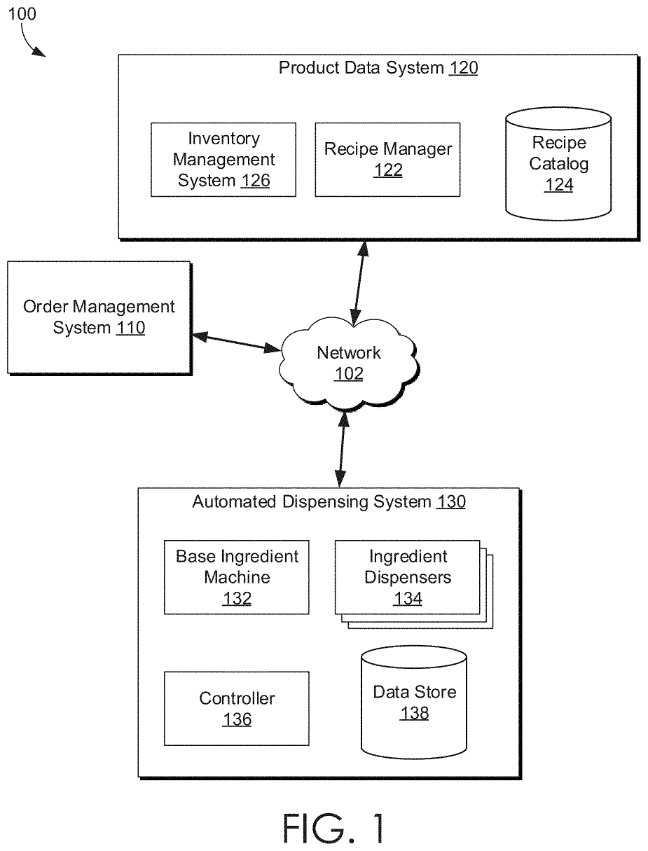

FIG. 1 illustrates an embodiment of a beverage management and dispensing environment 100 that includes a network 102, an order management system 110, a product data system 120, and an automated dispensing system 130. To simplify discussion and not to limit the present disclosure, FIG. 1 illustrates only one order management system 110, product data system 120, and automated dispensing system 130, though multiple may be used.

Any of the foregoing components or systems of the environment 100 may communicate via the network 102. Although only one network 102 is illustrated, multiple distinct and/or distributed networks 102 may exist. The network 102 can include any type of communication network. For example, the network 102 can include one or more of a wide area network (WAN), a local area network (LAN), a cellular network (for example, LTE, HSPA, 3G, and other cellular technologies), an ad hoc network, a satellite network, a wired network, a wireless network, and so forth. In some embodiments, the network 102 can include the Internet.

Any of the foregoing components or systems of the environment 100, such as any one or any combination of the order management system 110, the product data system 120, or the automated dispensing system 130 may be implemented using individual computing devices, processors, distributed processing systems, servers, isolated execution environments (for example, virtual machines, containers, etc.), shared computing resources, or so on. Furthermore, any of the foregoing components or systems of the environment 100 may be combined and/or may include software, firmware, hardware, or any combination(s) of software, firmware, or hardware suitable for the purposes described. For example, in some cases, the product data system 120, or portions thereof (e.g., the recipe manager 122 and/or the recipe catalog 124), may be integrated with the automated dispensing system 130.

### Order Management System

The order management system 110 can receive customer orders (sometimes referred to as beverage orders or orders) and communicate order information to an automated dispensing system 130 and/or a product data system 120. An order may be received by the order management system 110 from any of a variety of sources, such as from a barista entering a customer order locally at a coffee store in response to oral instructions from a customer ordering at an in-store counter or via a drive-thru ordering system, a customer entering a customer order locally via an in-store self-service kiosk, a customer using a mobile order and pay software application, a customer using an online ordering method, and/or other source.

The order management system 110 may include, or interface with, a web browser, a mobile application or “app,” a background process that performs various operations with or without direct interaction from a user, or a “plug-in” or “extension” to another application, such as a web browser plug-in or extension. In some cases, the order management system 110 may be hosted or executed by one or more host devices (not shown), which may broadly include any number of computing devices and/or virtual machine instances. Examples of an order management system 110 may include, without limitation, smart phones, point of sale systems, kiosks, tablet computers, handheld computers, wearable devices, laptop computers, desktop computers, servers, and so forth.

An order may include any of various order information including, but not limited to, a date, time, customer name, a food identifier, a beverage identifier, or an ingredient modifier(s). A beverage identifier can indicate the particular beverage that the customer is ordering. For example, the beverage identifier can be any identifier that identifies a particular beverage or a standard recipe associated with that beverage. A beverage identifier can include, but is not limited to, a beverage name or an alphanumeric code (for example, an SKU) associated with the beverage or a recipe for the beverage. Similarly, a food identifier can indicate a particular food that the customer is ordering.

As described herein, in some cases, a customer orders a particular beverage and chooses modifications to that beverage's standard recipe. The order management system 110 can capture and/or analyze the order to identify those modifications, which are generally referred to herein as ingredient modifiers. An ingredient modifier can indicate a modification to a standard recipe (or a modified recipe) associated with the particular beverage that the customer is ordering. The ingredient modifier can provide an indication of an additional ingredient (for example, an extra shot of espresso), a modification to an existing ingredient (for example, almond milk instead of 2% milk), an absence of an existing ingredient (for example, no ice, no whipped cream, no sweetener, etc.), or the like. Accordingly, in some cases, the customer's beverage order can be represented by a beverage identifier and/or one or more ingredient modifiers.

### Automated Dispensing System

An automated dispensing system 130 can include a base ingredient machine 132, a plurality of ingredient dispensers 134, a controller 136, and a data store 138. As described herein, the automated dispensing system 130 can be configured to automatedly dispense precise amount of ingredients in accordance with a particular recipe. For example, the controller 136 can obtain recipe information and can communicate instructions to the base ingredient machine 132 and/or the ingredient dispensers 134 to cause the base ingredient machine 132 and/or the ingredient dispensers 134 to dispense ingredients in accordance with a recipe information. For example, the base ingredient machine 132 and/or the ingredient dispensers 134 can include an electronic pump for facilitating precise distribution of the ingredient. The data store 138 (sometimes referred to as memory 138) can include or be implemented as cloud storage, such as Amazon Simple Storage Service (S3), Elastic Block Storage (EBS) or CloudWatch, Google Cloud Storage, Microsoft Azure Storage, InfluxDB, etc. The data store 138 can be made up of one or more data stores storing data similar to or the same as that of the recipe catalog 124, described herein.

### Product Data System

The product data system 120 can include a recipe manager 122, a recipe catalog 124, and an inventory management system 126. As described herein, the product data system 120 may be implemented using individual computing devices, processors, distributed processing systems, servers, isolated execution environments (for example, virtual machines, containers, etc.), shared computing resources, or so on.

### Recipe Manager

The recipe manager 122 can be used to manage, create, develop, or update recipes in the beverage management and dispensing environment 100. For example, the recipe manager 122 can maintain the recipe catalog 124 with recipe information. The recipe manager 122 can populate the recipe catalog 124 and/or update it over time with recipe information that receives and/or generates. As recipe information changes, the recipe manager 122 can update the recipe catalog 124. In this way, the recipe catalog 124 can retain an up-to-date database of recipe information.

In some cases, the order management system 110 and/or the automated dispensing system 130 can include a local data store 138 for storing recipe information. For example, the local data store 138 can include recipe information corresponding to recently created, developed, or updated orders associated with the order management system 110 and/or the automated dispensing system 130. In some cases, the recipe manager 122 can maintain the recipe catalog 124 by pinging the order management system 110 and/or the automated dispensing system(s) 130 for recipe information or passively receiving it based on the order management system 110 and/or the automated dispensing system(s) 130 independently reporting the recipe information. For instance, the recipe manager 122 can ping or receive information from the order management system 110 and/or the automated dispensing system(s) 130 at predetermined intervals of time, such as every X number of hours, or every X days, etc. In addition or alternatively, the order management system 110 and/or the automated dispensing system(s) 130 can be configured to automatedly send its recipe information to the recipe manager 122 and/or the recipe manager 122. In some cases, the recipe catalog 124 can be manually updated, such as by a beverage creator implemented recipe updates or new recipe rollouts.

Furthermore, the recipe manager 122 can transmit the recipe information to the order management system 110 and/or the automated dispensing system 130 via data packets, such as part of an update to some of all of the order management system 110 and/or the automated dispensing system(s) 130. For instance, the recipe manager 122 can communicate recipe updates to the automated dispensing system(s) 130 at predetermined intervals of time, such as every day, week, or month. In some cases, the recipe manager 122 provides the recipe information when the recipes, or updates thereto, become available from the recipe manager 122. In some cases, the recipe manager 122 provides the recipe information when a beverage creator further develops a recipe, or creates a test recipe. As another example, the automated dispensing system 130 can query the recipe manager 122 for recipe information, or can download recipe information from the recipe catalog 124.

### Recipe Catalog

The recipe catalog 124 can store recipe information. In some embodiments, the recipe information can include beverage identifiers, ingredient identifiers, ingredient modifiers, ingredient sequence instructions, etc. The recipe catalog 124 can be maintained (for example, populated, updated, etc.) by the recipe manager 122. As mentioned, in some embodiments, the recipe manager 122 and recipe catalog 124 can be separate or independent of the order management system 110 and/or the automated dispensing system 130. Alternatively, in some embodiments, the recipe manager 122 and/or recipe catalog 124 are part of the order management system 110 and/or the automated dispensing system 130. Furthermore, in some cases, the recipe catalog 124 can be separate from or included in, or part of, the recipe manager 122.

As described herein, a beverage identifier can be associated with a recipe for a beverage. A recipe can include a group of ingredients and/or a particular amount of each ingredient. Ingredients can include, but are not limited to, milk options (for example, 2%, nonfat, whole, breve, heavy cream, almond, coconut, oatmeal, soy), flavors (for example, apple brown sugar syrup, brown sugar syrup, caramel syrup, cinnamon dolce syrup, funnel cake syrup, hazelnut syrup, peppermint syrup, raspberry syrup, toffee nut syrup, vanilla syrup, or sugar free vanilla syrup), sauces (for example, mocha sauce, dark caramel sauce, pumpkin sauce, or white chocolate mocha sauce), add-ins (for example, chocolate malt powder or vanilla bean powder), sweeteners (for example, sugar, sugar in the Raw®, honey, Splenda®, stevia in the Raw®, classic syrup, cane sugar, or honey blend), etc.

Furthermore, a recipe can include a sequence of ingredients. For example, a recipe for a creamy coffee beverage could be to dispense hot espresso coffee extract into a cup, followed by two pumps of vanilla syrup, followed by a pump of white chocolate mocha sauce, followed by a fixed volume of steamed almond milk and finished with two pumps of toffee nut flavor. The recipe for a non-creamy beverage could be the same ingredients and quantities but dispensed in a different order (for example, dispense a pump of white chocolate mocha sauce, followed by two pumps of vanilla syrup, followed by a fixed volume of steamed almond milk and followed with two pumps of toffee nut flavor and finished by dispensing a hot espresso coffee extract on top). Thus, different beverages are made not only by varying the type and quantities of ingredients or modifiers (for example, sauces, syrups and flavors), but also by changing the order in which they are added to the beverage.

The recipe catalog 124 can store one or more beverage identifiers. In some embodiments, the beverage identifiers can be implemented as alphanumeric identifiers or other identifiers that can be used to uniquely identify one beverage identifier from another beverage identifier stored in the recipe catalog 124.

In some cases, each beverage identifier can identify a particular beverage. As an example, the particular beverage associated with a beverage identifier can include, but is not limited to, Caffè Mocha, Caffè Latte, Caffè Americano, Pumpkin Cream Cold Brew, Iced Brown Sugar Oatmilk Shaken Espresso, Iced Peach Green Tea Lemonade, Honey Citrus Mint Tea, Nitro Cold Brew, or the like.

Furthermore, each beverage identifier can be associated with one or more of a beverage characteristic (for example, beverage size, a base beverage (tea, coffee, etc.)), a recipe, a group of recipe ingredients, one or more ingredient modifiers, ingredient sequence instructions, and/or information regarding a recipe generation policy.

The recipe catalog 124 can include or be implemented as cloud storage, such as Amazon Simple Storage Service (S3), Elastic Block Storage (EBS) or CloudWatch, Google Cloud Storage, Microsoft Azure Storage, InfluxDB, etc. The recipe catalog 124 can be made up of one or more data stores storing data that has been received from one or more of the order management system 110, the automated dispensing system 130, or the recipe manager 122, or data that has been received directly into the recipe catalog 124. The recipe catalog 124 can be configured to provide high availability, highly resilient, low loss data storage. The recipe catalog 124 can include Amazon CloudWatch metrics. In some cases, to provide the high availability, highly resilient, low loss data storage, the recipe catalog 124 can store multiple copies of the data in the same and different geographic locations and across different types of data stores (for example, solid state, hard drive, tape, etc.). Further, as data is received at the recipe catalog 124 it can be automatically replicated multiple times according to a replication factor to different data stores across the same and/or different geographic locations.

A non-limiting example of a data structure for storing the recipe information is illustrated in Table 1.

TABLE 1

| Beverage | Beverage | | | Ingredient | Ingredient |
|---|---|---|---|---|---|
| Identifier | Name | Size | Ingredient Identifier | Amount | Modifier |
| 65 | Caffè | Grande | hot espresso | 2 fluid ounces | |
| | Mocha | | mocha sauce | 4 fluid ounces | |
| | | | steamed 2% milk | 8 fluid ounces | |
| 66 | Caffè | Grande | hot espresso | 3 fluid ounces | +1 ounce |
| | Mocha | | mocha sauce | 4 fluid ounces | almond |
| | | | steamed almond milk | 7 fluid ounces | |

With reference to the example in Table 1, the beverage identifier 65 is associated with the beverage name “Calfè Mocha” and beverage size “Grande.” In addition, the beverage identifier 65 is associated with a plurality of ingredient identifiers (hot espresso, mocha sauce, steamed 2% milk) and a plurality of corresponding ingredient amounts (2 fluid ounces, 4 fluid ounces, 8 fluid ounces). In this example, the associated ingredients and ingredient amounts correspond to the recipe for the beverage. Furthermore, in this example, the beverage identifier 65 is not associated with any ingredient modifiers. In some cases, a beverage that is not associated with any ingredient modifiers is referred to as a “standard” or default beverage. Thus, in this example, the beverage identifier 65 can correspond to the standard beverage recipe the Grande Caffè Mocha.

Table 1 also includes a row for the beverage identifier 66. Similar to the beverage identifier 65, the beverage identifier 66 is also associated with the beverage name “Calfè Mocha” and beverage size “Grande.” However, the beverage identifier 66 is additionally associated with several ingredient modifiers, namely “+1 ounce” of espresso and a replacement of “2%” milk with “almond” milk. Looking at both of these examples in Table 1, note that the total aggregate volume of ingredients is 14 ounces, despite beverage identifier 65 being associated with an additional ounce of espresso. This is due to the recipe have a reduced the volume of milk in response to an increase in the volume of expresso.

It will be understood that the beverage identifier entries can be configured in a variety of ways. It will be understood that the beverage identifier data structure can include fewer or additional information. For example, sequence instructions for the recipe can be included or beverage sizes may be omitted, etc.

### Inventory Management System

The inventory management system 126 can be used to manage, track, or order inventory at one or more stores. For example, as mentioned, the automated dispensing system 130 can be configured to dispense precise amounts of ingredients. Due to the precision, a precise amount of leftover ingredients can be determined and/or tracked. As additional ingredients are used, the inventory management system 126 can update to reflect the change. In this way, the inventory management system 126 can improve the ability to determine and track detailed actuals for ingredient consumption, which advantageously reduces manual inventory counting and estimation, thereby improving accuracy in tracking inventory and planning for inventory restocking. In some cases, the inventory management system 126 is implemented as part of the automated dispensing system 130.

### Example Automated Dispensing System

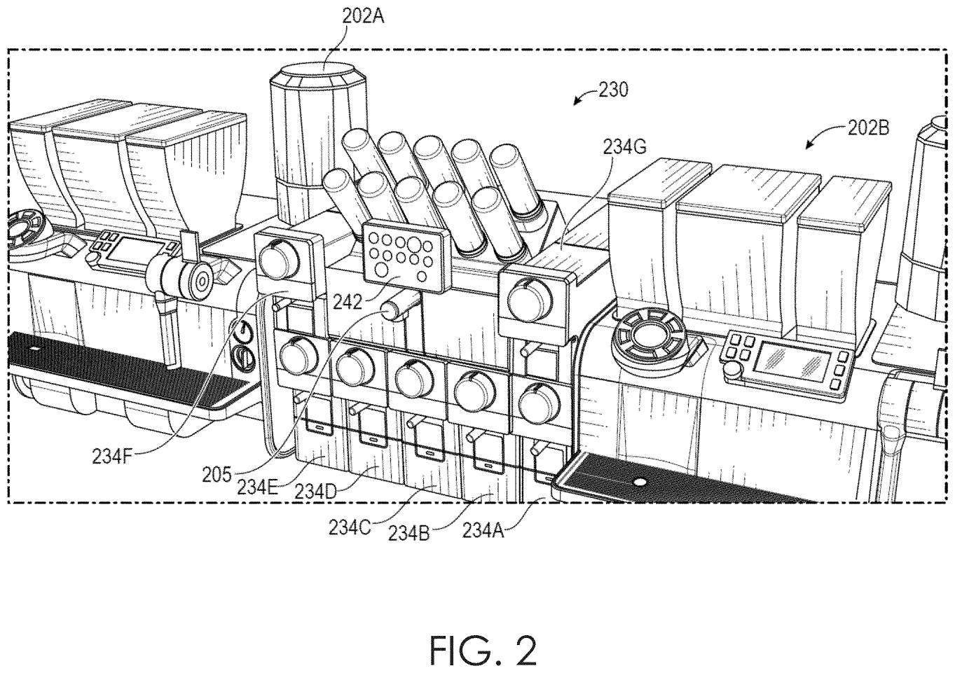

FIG. 2 illustrates an example automated dispensing system 230 for automatedly dispensing beverage ingredients in accordance with a recipe. The automated dispensing system 230 includes a base ingredient machine 202A, 202B, a plurality of dispensers 234A, 234B, 234C, 234D, 234E, 234F, 234G (individually or collectively referred to as dispense 234 or dispensers 234), a dispenser spout 205, a display screen 242, and/or a controller (such as controller 136 of FIG. 1). The automated dispensing system 230 may be an embodiment of the automated dispensing system 130 of FIG. 1.

The base ingredient machine 202A, 202B can be configured to brew or dispense a base ingredient, such as espresso, coffee, tea, etc. For example, a base ingredient machine 202A, 202B can include, but is not limited to, a coffee espresso machine or a tea machine. It will be understood that the base ingredient machines 202A, 202B of FIG. 2 merely represent examples and thus FIG. 2 should not be construed as limiting.

The dispenser spout 205 is configured to dispense a liquid, such as hot or cold water, an ingredient or combination of ingredients, or a prepared beverage. In some cases, the dispenser spout 205 may facilitate manual dispensing, for example by a barista. In some cases, the dispenser spout 205 facilitates automated dispensing, such as described herein. The dispenser spout 205 may be a centralized dispenser spout, such that some or all of a set of ingredients are configured to dispense through the dispenser spout 205. In addition or alternatively, the dispenser spout 205 may be configured to dispense a single ingredient. For example, the automated dispensing system 230 may include a plurality of dispenser spouts 205, such as one for each ingredient.

The display screen 242 may include a touchscreen display configured to receive user input based on pressing of graphical buttons or icons on a graphical user interface of the display screen 242, in addition to displaying graphics, animations, or alphanumeric textual information to the barista. In addition or alternatively, the display 242 can display information or instructions to the barista or other user, such as indications of errors, warnings, or alerts, instructions for a recipe, or other beverage information.

The dispensers 234 may be controlled from, or by, one or more controllers. For example, the individual dispensers 234 may be controlled from, or by, a single centralized controller that supplies power and control signals (which may include data or other information, such as recipe information) to each of the dispensers 234. In other configurations, each dispenser 234 may be controlled by its own dedicated local controller or subgroups of dispensers may be controlled by a controller. Each dispenser 234 can be changed or adapted to dispense any ingredient by changing certain pump characteristics or dispensing parameters (for example, the pump speed, timing, volumetric dispensation, and algorithm of dispensing).

In some cases, the dispensers 234 are modular. For example, the dispensers 234 can be added to or removed from the automated dispensing system 230 quickly and easily in different configurations without negatively affecting the other dispensers 234 or the operation of the automated dispensing system 230.

The dispense instructions (for example, amount dispensed) may be input by an individual barista through a user input device (for example, the display 242) on the dispenser or remote from the dispenser, for example if the dispense instructions deviate from a standard recipe for the beverage. Alternatively, the dispense instructions may be automatically received by the automated dispensing system 230 from the order management system 110 or the product data system 120. Even when the dispense instructions are received from the order management system 110 or the product data system 120, the user (for example, barista) may be able to modify the dispense instructions manually (for example, if a customer changes their mind after an initial time of sale).

It will be understood that the automated dispensing system 230 can include fewer or more components, as desired. For example, the automated dispensing system 230 can be an embodiment of the automated dispensing system described in greater detail in U.S. Pub. No. 2021/0221667, filed Jan. 14, 2021, entitled “AUTOMATED DISPENSING SYSTEM FOR CUSTOMIZED BEVERAGES,” which is hereby incorporated by reference in its entirety and includes concepts that are compatible with and can be used in conjunction with any combination of the embodiments and/or features described herein.

### Generating a Recipe for a Modified Version of a Beverage

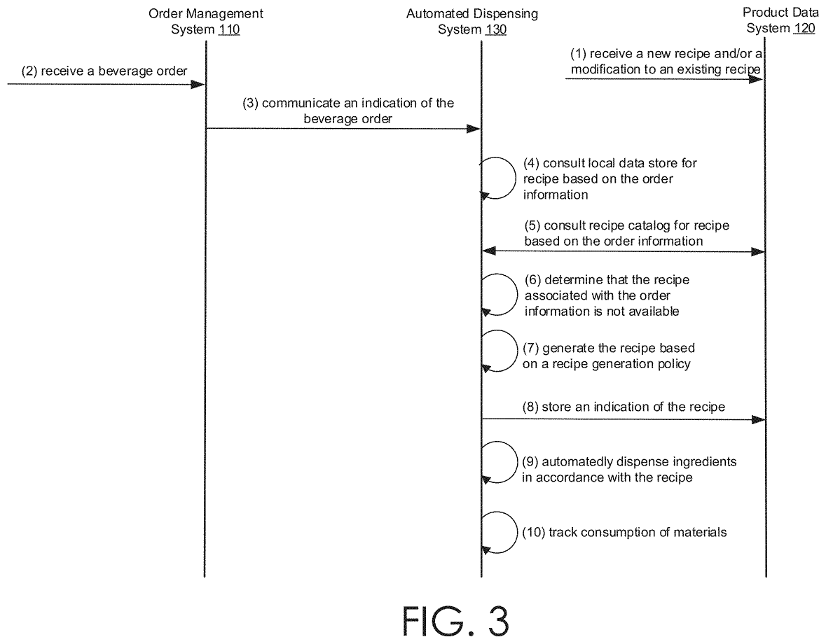

FIG. 3 is a data flow diagram illustrating an embodiment of the data flow and communications between a variety of the components of the beverage management and dispensing environment 100 to dynamically generate a recipe for a beverage in accordance with a recipe generation policy. The data flow diagram of FIG. 3 illustrates an example of data flow and communications between an order management system 110, a product data system 120 (e.g., the inventor management system 126, the recipe manager 122, and/or the recipe catalog 124), and an automated dispensing system 130. However, it will be understood, that in some of embodiments, one or more of the functions described herein with respect to FIG. 3 can be omitted, performed concurrently or in a different order and/or performed by a different component of the beverage management and dispensing environment 100. Accordingly, the illustrated embodiment and description should not be construed as limiting.

At (1), the product data system 120 receives a new recipe and/or an update or modification to an existing recipe. As described herein, the product data system 120 can include a recipe catalog 124 that stores recipe information, such as recipe identifiers (e.g., beverages names or SKUs) and associated ingredients, ingredient amounts, sequence instruction, etc. In some cases, a beverage creator can interact with the product data system 120 to communicate the new recipe and/or an update or modification to an existing recipe. For example, the beverage creator can introduce or activate seasonal recipes, trial or test recipes, modifications to recipes, etc. The recipe manager 122 can update the recipe catalog 124 with this information. Furthermore, in some cases, some or all of the contents of the recipe catalog 124 can be communicated to one, some, or all of the automated dispensing systems 130.

At (2), the order management system 110 receives a beverage order for a first beverage. The beverage order can be received by the order management system 110 from any of a variety of sources, such as from a barista entering a beverage order locally at a coffee store in response to oral instructions from a customer ordering at an in-store counter or via a drive-thru ordering system, a customer entering a beverage order locally via an in-store self-service kiosk, a customer using a mobile order and pay software application, a customer using an online ordering method, and/or other source.

At (3), the order management system 110 communicates an indication of the beverage order to an automated dispensing system 130. In some cases, to communicate the order to the automated dispensing system 130, the order management system 110 receives the order and forwards order information to the automated dispensing system 130.

At (4), the automated dispensing system 130 determines whether a recipe associated with the order information is available in local storage (e.g., data store 138) and/or remote storage (e.g., recipe catalog 124). For example, as described herein, the automated dispensing system 130 can include and/or maintain a local data store 138 that includes a group of recipes, such as a copy of recent information stored in the recipe catalog 124. Using the order information, the automated dispensing system 130 can consult its local data store 138 to determine whether an associated recipe is available. For example, the automated dispensing system 130 can compare at least some of the order data to data stored in the local data store 138 to determine whether an associated order is available. In some cases, if the recipe is available in the local data store 138, the automated dispensing system 130 can identify the recipe and proceed to interaction (9), where the automated dispensing system 130 dispenses the beverage.

In some cases, if the recipe is unavailable in the local data store 138, then the automated dispensing system 130 can check the recipe catalog 124 for the recipe. For example, at (5), the automated dispensing system 130 communicates a request or query for the recipe to the recipe manager 122, for example via data packets. In some cases, as part of the request, the automated dispensing system 130 communicates at least some of the order information, such as the beverage identifier and the ingredient modifier(s). In some cases, as part of the request, the automated dispensing system 130 communicates all of the order information. In some cases, the communication of the order information (or portion thereof) can itself function as the request, so a separate request need not be sent. In some cases, the automated dispensing system 130 consults the recipe catalog 124 before or instead of consulting its local data store 138.

At (6), the automated dispensing system determines that a recipe associated with the order information is not available.

At (7), the automated dispensing system 130 generates the recipe based on order information and a recipe generation policy. For example, as mentioned, the information can include data, such as a beverage identifier and one or more ingredient modifiers. As part of generating the recipe, the automated dispensing system 130 can use the beverage identifier to obtain the standard recipe from the data store 138. Furthermore, the automated dispensing system 130 can obtain a recipe generation policy, which can be stored in the data store 138 as well. As described herein, to generate the recipe, the automated dispensing system 130 can make modifications to the standard recipe (or another recipe) based on the ingredient modifier(s) and/or the recipe generation policy.

The recipe generation policy can indicate can indicate how to adjust or create a recipe in response to ingredient modifications. For example, the recipe generation policy can include a particular set of rules or instructions relating to how to modify the ingredients, the ingredient amounts, the ingredient order, etc. so that the ingredient modification is implemented and/or other criteria (for example, flavor profile, calorie count, dietary restriction, volume threshold, etc.) are satisfied.

In some cases, the recipe generation policy indicates that the total volume of the ingredients should satisfy a volume threshold. For example, if the ingredient modifier indicates the presence of an additional ingredient or an increased amount of an existing ingredient as compared to a standard recipe, the recipe generation policy can indicate to reduce at least one existing ingredient such that the total volume of the new recipe does not exceed a volume threshold. As another example, if the ingredient modifier indicates the absence of an existing ingredient or a decreased amount of an existing ingredient as compared to a standard recipe, the recipe generation policy can indicate to increase at least one existing ingredient such that the total volume of the new recipe does not exceed a volume threshold. The particular ingredient(s) that are increased or decreased can be determined using a plurality of techniques. For example, in some cases, the particular ingredient can be the main ingredient, such as the ingredient with the largest volume according to the standard recipe. As another example, in some cases, the particular ingredient can be the complementary to the modified ingredient. For example, if a relatively bitter ingredient (for example, espresso) is added, then a similarly bitter ingredient can be removed and/or a sweet ingredient (for example, mocha sauce) can be added to compensate for the likely change in taste.

The volume threshold can vary across embodiments. For example, the volume threshold can be based on a size of the cup (for example, small, medium, large), the presence of absence of particular ingredients (for example, whipped cream), user preference, etc. For example, in some cases, a size small cup holds approximately 12 oz. of fluid. In some such cases, the volume threshold can be approximately 12 oz. Alternatively, the volume threshold may be some offset (for example, 0.25, 0.5, or 1 oz.) from 12 oz., so that the cup does not overflow or spill. As another example, if modified recipe includes whipped cream, the volume threshold can be reduced, for example to leave enough room for the whipped cream to be added after the beverage is prepared.

In some cases, the recipe generation policy indicates how to compensate for particular ingredients so that the beverage substantially retains its flavor profile, as compared to the standard recipe. Consider a scenario in which a customer requests an additional shot of espresso for her beverage. In such a scenario, simply adding the additional shot of espresso to the standard recipe, without modifying the other ingredients of the recipe, may result in a beverage with a more bitter taste, as compared to the standard recipe. Accordingly, the recipe generation policy may indicate a specific set of rules for compensating for the increased bitterness introduced by the additional espresso shot. For example, the recipe generation policy may indicate to compensate for the espresso shot by adding chocolate sauce (or other flavor in the standard recipe) and/or removing steamed milked (for example, proportional to the volume of added espresso and chocolate sauce). By dynamically generating beverage recipes based on ingredient modifications, the system can advantageously preserve the flavor profile or quality of a beverage, notwithstanding the ingredient modifications.

In some implementations, the recipe generation policy indicates to change all of the ingredients proportionally, in response to the presence of an additional ingredient or absence of an existing ingredient. Consider a scenario in which a standard beverage includes: 3.5 oz. steamed milk, 2 oz. chocolate sauce, and 2 oz. espresso. Further, consider that the ingredient modifier indicates an additional shot of espresso. For such a scenario, the recipe generation policy can indicate to decrease the steamed milk and the chocolate sauce proportionally to account for the additional 1.5 oz. of espresso, such that the generated recipe includes approximately 2.54 oz. steamed milk, 1.45 oz. chocolate sauce, and 3.5 oz. espresso. The recipe generation policy can indicate similar proportional adjustments when ingredients are removed from the standard recipe.

In some cases, the recipe generation policy indicates make the adjustment to the recipe is accordance with the ingredient modifier, but make no other adjustments to the ingredients. For example, returning to the example above in which a standard beverage includes: 3.5 oz. steamed milk, 2 oz. chocolate sauce, and 2 oz. espresso, and the ingredient modifier indicates an additional shot of espresso, the recipe generation policy can indicate to retain all original ingredients, such that the generated recipe includes approximately 3.5 oz. steamed milk, 2 oz. chocolate sauce, and 3.5 oz. espresso. In some such cases, this may require the system to utilize a larger cup (for example, the next size up) when dispensing the beverage.

At (8), the automated dispensing system 130 stores an indication of the generated recipe in the data store 138 and/or in the recipe catalog 124. As described herein, the automated dispensing system 130 can maintain the data store 138 with up-to-date recipe information. Similarly, the recipe manager 122 can maintain the recipe catalog 124 with up-to-date recipe information. Accordingly, in some cases, each time the automated dispensing system 130 generates a new recipe, the automated dispensing system 130 can populate the data store 138 and/or the recipe catalog 124 with the generated recipe. In some cases, as part of populating the generated recipe, the automated dispensing system 130 can generate a beverage identifier associated with the generated recipe. Furthermore, as described herein, the data store 138 and/or the recipe catalog 124 can store associations between beverage identifiers, recipes, ingredient modifiers, etc. By storing the generated recipe, if the order occurs again, the automated dispensing system 130 can retrieve the recipe information, rather than regenerating the recipe. Furthermore, by storing generated recipes, recipe “gaps” are filled.

At (9), the automated dispensing system 130 automatedly dispenses the ingredients in accordance with the generated recipe. As described herein, the automated dispensing system 130 can include a controller 136, one or more ingredient dispensers 134, and/or a base ingredient machine 102. Each ingredient dispenser 134 can be configured to store one or more ingredients, and can be controlled by the controller 136 to dispense a precise amount of the respective ingredient. The controller 136 obtains the recipe and communicates instructions to the respective ingredient dispensers 134 (for example, to a dispenser pump) based on the recipe. The pumps in the ingredient dispensers 134 then dispense the exact volume of ingredient into a vessel through a dispensing spout.

At (10), the automated dispensing system 130 tracks consumption of materials based at least in part on the dispensing of the ingredients in accordance with the generated recipe. As mentioned, by improving precision of the dispensing system 130, the precise amounts of utilized ingredients can be determined and tracked. In this way, the automated dispensing system 130 can improve the ability to determine and track detailed actuals for ingredient consumption, which advantageously reduces manual inventory counting and estimation, thereby improving accuracy in tracking inventory and planning for inventory restocking. In some cases, the product data system 120 (e.g., the inventory management system 126) can track the inventory and/or managed automated order of additional supplies based on the inventory tracking.

It will be understood that the various interactions described with respect to FIG. 3 can be implemented in a variety of orders and/or can be implemented concurrently or in an altered order, as desired. For example, in some cases, the automated dispensing system 130 can concurrently store the recipe information in the data store 138 and the recipe catalog 124. In some cases, the data flow of FIG. 3 occurs in real-time or near-real time. In this way, the recipe is generated and/or the beverage dispensed without causing a significant delay for the customer.

Furthermore, it will be understood that fewer, more, or different blocks can be used as part of the data flow of FIG. 3. For example, in some cases, the data of the recipe catalog 124 is available for download by the automated dispensing system 130, or the data of the recipe catalog 124 may be part of a software update that the recipe manager 122 periodically distributes to the automated dispensing system(s) 130. In this way, in some cases, the data stored locally on the automated dispensing system 130 is the same as the data stored in the recipe catalog, and thus interaction (4) may be omitted.

As another example, in some cases, the automated dispensing system 130 may performed one or more of interactions (4), (5), or (6). For example, the automated dispensing system 130 may store the recipe generation policy and thus can generate a recipe itself, without having to interaction with the recipe manager 122. In some such cases, the automated dispensing system 130 can communicate an indication of the generated recipe to the recipe manager 122, so that the recipe manager 122 can update the recipe catalog 124.

### Managing a Recipe Catalog

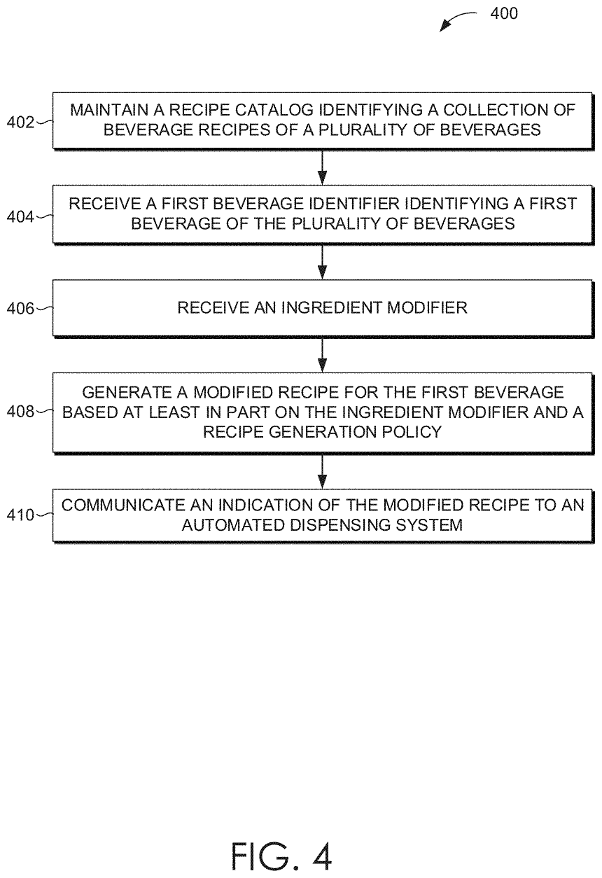

FIG. 4 is a flow diagram illustrative of an embodiment of a routine 400 implemented by the recipe manager 122 to dynamically generate a recipe for a beverage in accordance with a recipe generation policy. Although described as being implemented by the recipe manager 122, it will be understood that the elements outlined for routine 400 can be implemented by one or more computing devices or components that are associated with the beverage management and dispensing environment 100, such as, but not limited to, the product data system 120, the recipe catalog 124, the order management system 110, or the automated dispensing system 130. Thus, the following illustrative embodiment should not be construed as limiting.

At block 402, the recipe manager 122 maintains the recipe catalog 124. In some cases, the recipe manager 122 maintains the recipe catalog 124 by communicating with some or all of the automated dispensing systems 130 or the order management system 110. For example, in some cases, an automated dispensing system 130 and/or an order management system 110 can obtain or manage recipe information, such as indications of available ingredients, customer-created recipes, and/or recipe modifications, etc. The recipe manager 122 can receive the recipe information and use it to update and/or maintain the recipe catalog 124. In certain embodiments, the recipe manager 122 can communicate with the automated dispensing system 130 and/or the order management system 110 to receive recipe information, from which it can determine additional recipes or recipe modifications, and can use that information to maintain the recipe catalog 124.

In some cases, the recipe manager 122 communicates with the automated dispensing systems 130 and/or the order management system 110 by pinging them and receiving a response. For instance, the recipe manager 122 can ping the automated dispensing systems 130 at predetermined intervals of time, such as every 60 seconds, or every 30 or 60 minutes, or every 4, 8, or 12 hours, etc. In certain embodiments, the automated dispensing systems 130 can be configured to automatically send recipe data to the recipe manager 122.

The recipe catalog 124 can include, among other things, a collection of beverage recipes for a plurality of beverages. For example, for each beverage, the recipe catalog 124 can include a standard recipe associated with a collection of ingredients and corresponding amounts of each ingredient. In some cases, the recipe catalog 124 includes multiple standard recipes for a particular beverage, such as a different standard recipe for each available size of the beverage. In some cases, for a particular beverage, the ingredients and/or ingredient proportions are the same between beverage sizes. Alternatively, the ingredients and/or ingredients proportions may vary across beverage sizes. Ingredients can include, but are not limited to, sauces, syrups, sweeteners, colors, flavors, ice, water, dairy or non-dairy products, espresso, whipped cream, etc.

In some cases, the recipe information includes one or more modified recipes. A modified recipe can be an altered version of a standard recipe, such as a version with additions or subtractions as compared to the respective standard recipe. In some cases, the modified recipes are associated with ingredient modifiers. For example, as described herein, an ingredient modifier can indicate the addition or removal of an ingredient, as compared to a standard recipe.

At block 404, the recipe manager 122 receives a first beverage identifier identifying a first beverage of the plurality of beverages in the recipe catalog 124. As described herein, the first beverage can correspond to a beverage that is associated with a standard or default recipe. For example, the recipe manager 122 can look up the first beverage identifier in the recipe catalog 124 to determine various information associated with the beverage, such as the recipe information, the ingredients, the beverage name, etc.

At block 406, the recipe manager 122 receives an ingredient modifier. As described herein, the ingredient modifier can indicate a modification of the standard beverage. For example, the ingredient modifier can indicate the addition of a new ingredient (and the amount of the addition) to the recipe. As another example, the ingredient modifier can indicate the addition of an existing ingredient (and the amount of the addition) to the recipe. As another example, the ingredient modifier can indicate the reduction or removal of an existing ingredient (and the amount of the reduction) to the recipe. As another example, the ingredient modifier can indicate the replacement of an existing ingredient with another ingredient. Although described as a single ingredient modifier, it will be understood that any number of ingredient modifiers can be received, for example based on the beverage order.

At block 408, the recipe manager 122 generates a modified recipe for the first beverage. As described herein, the recipe manager 122 generates the modified recipe based at least in part on the first beverage identifier, the ingredient modifier, and a recipe generation policy. The recipe generation policy can include a specific set of rules or instructions for modifying the ingredients to implement the ingredient modification(s). As described herein, the recipe generation policy can vary across embodiments. For example, in some cases, the recipe generation policy indicates that an aggregate volume of the standard ingredients should be equal to an aggregate volume of the modified ingredients. As another example, in some cases, the recipe generation policy indicates to retain the particular ingredient proportions from the standard recipe when generating the modified recipe.

At block 410, the recipe manager 122 communicates the modified recipe to an automated dispensing system 130. The automated dispensing system 130 can automatedly dispense the ingredients in accordance with the modified recipe. As described herein, the automated dispensing system 130 can include a controller 136, one or more ingredient dispensers 134, and/or a base ingredient machine 102. Each dispenser 134 can be configured to store one or more ingredients, and can be controlled by the controller 136 to dispense a precise amount of the respective ingredient. The controller 136 obtains the recipe and communicates instructions to the respective dispensers 234 (for example, to a dispenser pump) based on the recipe. The pumps in the dispensers 234 then dispense the exact volume of ingredient into a vessel through a dispensing spout.

### Terminology

Although certain embodiments have been described herein in connection with flavors, sauces, or syrups for coffee or tea beverages, the systems described herein can be used for any type of ingredient or food product. For example, in some embodiments, the systems herein can be used to deliver fluid or solid ingredients, such as ketchup, mustard, barbecue sauce, cheese sauce, relish, onions, etc. In some embodiments, the systems herein can be used to produce other types of beverages such as sodas, juices, smoothies, milkshakes, etc.

Conditional language used herein, such as, among others, “can,” “might,” “may,” “for example,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Depending on the embodiment, certain acts, events, or functions of any of the processes or algorithms described herein can be performed in a different sequence, can be added, merged, or left out altogether (for example, not all described operations or events are necessary for the practice of the algorithm). Moreover, in certain embodiments, operations or events can be performed concurrently.

The various illustrative logical blocks, modular dispensers, routines, and algorithm steps described in connection with the embodiments disclosed herein can be implemented as electronic hardware, computer software, or combinations of both. To clearly illustrate this interchangeability of hardware and software, various illustrative components, blocks, modular dispensers, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modular dispensers described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

While the above detailed description has shown, described, and pointed out novel features as applied to various embodiments, it can be understood that various omissions, substitutions, and changes in the form and details of the devices or algorithms illustrated can be made without departing from the spirit of the disclosure. For example, although different numbers have been used for similar components or features in different figures (for example, different numbers have been used for the dispenser modules, displays, controllers, etc.), the structural and functional features described in connection with one figure, embodiment, or numbered element may be incorporated into the different-numbered components or features, and vice-versa. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed:

1. A method comprising:
maintaining a recipe catalog identifying a collection of beverage recipes for a plurality of beverages, wherein the collection of beverage recipes comprises a standard recipe for a first beverage of the plurality of beverages, wherein the standard recipe comprises a first group of ingredients and a measure associated with each ingredient of the first group of ingredients;
receiving a first beverage identifier identifying the first beverage;
receiving an ingredient modifier, wherein the ingredient modifier indicates a modification to at least one of the first group of ingredients or a respective measure of a particular ingredient of the first group of ingredients;
generating a modified recipe for the first beverage based at least in part on the standard recipe, the ingredient modifier, and a recipe generation policy, wherein the modified recipe comprises a second group of ingredients and a measure associated with each ingredient of the second group of ingredients; and
communicating an indication of the modified recipe to an automated dispensing system comprising a plurality of dispensers, wherein a controller of the automated dispensing system causes the plurality of modular dispensers to dispense the second group of ingredients in accordance with the modified recipe.

2. The method of claim 1, wherein the ingredient modifier indicates a presence of an additional ingredient, wherein the first group of ingredients does not include the additional ingredient, and wherein the second group of ingredients includes the additional ingredient.

3. The method of claim 1, wherein the ingredient modifier indicates a modification of a first measure of a first ingredient of the first group of ingredients.

4. The method of claim 1, wherein the second group of ingredients is the same as the first group of ingredients, and wherein a first measure of a first ingredient of the first group of ingredients is different from a second measure of the first ingredient of the second group of ingredients.

5. The method of claim 1, wherein the recipe generation policy indicates that an aggregate volume of the first group of ingredients should be equal to an aggregate volume of the second group of ingredients.

6. The method of claim 1, wherein the standard recipe indicates particular proportions for the first group of ingredients, wherein the recipe generation policy indicates to retain the particular proportions for the second group of ingredients.

7. The method of claim 1, wherein the ingredient modifier indicates a presence of an particular amount of an additional ingredient, wherein said generating the modified recipe comprises proportionately modifying the measures of the first group of ingredients such that the aggregate volume of the first group of ingredients according to the standard recipe is equal to an aggregate volume of the second group of ingredients according to the modified recipe.

8. The method of claim 1 further comprising storing the modified recipe for the first beverage in the recipe catalog for later retrieval.

9. The method of claim 1, wherein said receiving the first beverage identifier and the first ingredient modifier occurs responsive to a beverage order, wherein the beverage order includes a modification of the first beverage.

10. The method of claim 1, wherein the automated dispensing system is one of a plurality of automated dispensing systems, wherein said communicating the indication of the modified recipe for the first beverage comprises communicating the indication of the modified recipe for the first beverage to each of the plurality of automated dispensing systems.

11. The method of claim 1 further comprising:
receiving a request for the modified recipe from the automated dispensing system,
wherein said communicating the indication of the modified recipe is responsive to receiving the request.

12. The method of claim 1 further comprising:
maintaining an inventory database indicating remaining amounts of a set of ingredients; and
responsive to the automated dispensing system dispensing the second group of ingredients in accordance with the modified recipe, updating the inventory database to reduce the inventory associated with the second group of ingredients based on amounts dispensed.

13. A computing system comprising:
memory storing a recipe catalog identifying a collection of beverage recipes for a plurality of beverages, wherein the collection of beverage recipes comprises a standard recipe for a first beverage of the plurality of beverages, wherein the standard recipe comprises a first group of ingredients and a measure associated with each ingredient of the first group of ingredients; and
one or more processors coupled to the memory and configured to:
receive a first beverage identifier identifying the first beverage,
receive an ingredient modifier, wherein the ingredient modifier indicates a modification to at least one of the first group of ingredients or the measure of a particular ingredient of the first group of ingredients,
generate a modified recipe for the first beverage based at least in part on the standard recipe, the ingredient modifier, and a recipe generation policy, wherein the modified recipe comprises a second group of ingredients and a measure associated with each ingredient of the second group of ingredients, and
communicate an indication of the modified recipe to an automated dispensing system comprising a plurality of dispensers, wherein a controller of the automated dispensing system causes the plurality of modular dispensers to dispense the second group of ingredients in accordance with the modified recipe.

14. The computing system of claim 12, wherein the ingredient modifier indicates a presence of an particular amount of an additional ingredient, wherein to generate the modified recipe, the one or more processors are configured to proportionately modify the measures of the first group of ingredients such that the aggregate volume of the first group of ingredients according to the standard recipe is equal to an aggregate volume of the second group of ingredients according to the modified recipe.

15. The computing system of claim 12, wherein the one or more processors are configured to store the modified recipe for the first beverage in the recipe catalog for later retrieval.

16. The computing system of claim 12, wherein the one or more processors are configured to receive the first beverage identifier and the first ingredient modifier responsive to a beverage order, wherein the beverage order includes a modification of the first beverage.

17. The computing system of claim 12, wherein the automated dispensing system is one of a plurality of automated dispensing systems, wherein to communicate the indication of the modified recipe for the first beverage, the one or more processors are configured to communicate the indication of the modified recipe for the first beverage to each of the plurality of automated dispensing systems.

18. Non-transitory computer readable media comprising computer-executable instructions that, when executed by one or more processors, cause the one or more processors to:
maintain a recipe catalog identifying a collection of beverage recipes for a plurality of beverages, wherein the collection of beverage recipes comprises a standard recipe for a first beverage of the plurality of beverages, wherein the standard recipe comprises a first group of ingredients and a measure associated with each ingredient of the first group of ingredients;
receive a first beverage identifier identifying the first beverage;
receive an ingredient modifier, wherein the ingredient modifier indicates a modification to at least one of the first group of ingredients or the measure of a particular ingredient of the first group of ingredients;
generate a modified recipe for the first beverage based at least in part on the standard recipe, the ingredient modifier, and a recipe generation policy, wherein the modified recipe comprises a second group of ingredients and a measure associated with each ingredient of the second group of ingredients; and
communicate an indication of the modified recipe to an automated dispensing system comprising a plurality of dispensers, wherein a controller of the automated dispensing system causes the plurality of modular dispensers to dispense the second group of ingredients in accordance with the modified recipe.

19. The non-transitory computer readable media of claim 12, wherein the ingredient modifier indicates a presence of an additional ingredient, wherein the first group of ingredients does not include the additional ingredient, and wherein the second group of ingredients includes the additional ingredient.

20. The non-transitory computer readable media of claim 12, wherein the ingredient modifier indicates a modification of a first measure of a first ingredient of the first group of ingredients.
